(19) United States
(12) Patent Application Publication
(10) Pub. No.: US 2009/0084326 A1
(43) Pub. Date: Apr. 2, 2009

(54) Pet curtain

(76) Inventor: David J. Watzke, Placentia, CA (US)

Correspondence Address: STOUT, UXA, BUYAN & MULLINS LLP, 4 VENTURE, SUITE 300, IRVINE, CA, 92618, US

(21) Appl. No.: 11/904,746

(22) Filed: Sep. 28, 2007

(51) Int. Cl. A01K 29/00

(52) U.S. Cl. 119/843; 119/712

(57) ABSTRACT

The present invention is drawn to a pet curtain and methods for its use. In other embodiments the invention is directed to a door or window frame assembly for permitting the ingress or egress of pets between a room and a desired location.

### FIELD OF THE INVENTION

The present invention concerns methods and apparatus for permitting the ingress and egress of animals, such as dogs and cats, from one room to another or from an outside area to an inside area, or vice versa.

### BACKGROUND OF THE INVENTION

The percentage of U.S. households with pets has jumped from 56 percent in 1988 to 63 percent in 2007, according to the American Pet Products Manufacturers Association Inc. In most pet owning households, for example, those in which a dog or a cat is part of the non-human family, it is necessary that the pet spend at least some time outside in order to relieve themselves. Other reasons for a pet to spend time significant time outdoors include playing and/or warning the family of the approach of strangers, and other “watchdog” functions.

At the same time, most pet owners, both children and adults, wish to permit the pet to spend time within the home with the family. Indeed, many pets spend more time indoors than outdoors.

Although a pet owner may open a door or window for the pet or take the animal for a walk whenever a pet wishes to go outside, this can easily become tiresome and lead to undesirable behavior in pets; for example, the pet may become accustomed to the owner taking the pet for a walk, and may bark, bite, scratch at the door, or exhibit other noisy, destructive, or distracting behavior each time the pet desires to exit or enter the house or a room.

Accordingly, some pet owners have installed pet doors that allow their pets to enter or exit the dwelling, or a room within the dwelling, when the pet desires. These pet doors have the advantage of not requiring the owner or owners to actively facilitate the entry or exit of the pet.

Typically, pet doors are permanent or semi-permanent alterations of an existing door in which a square portion of the lower half of the door large enough to accommodate the height and breadth of the pet is cut away to define an opening through which the pet may walk between rooms or the interior and exterior of the house. Often these openings are surrounded by a frame, which may hold a rubber or plastic flap to prevent rain, dust, or insects from easily entering the house. Additionally, the frame may include an latchable and/or lockable insert which can be lowered to close the opening, thus preventing the pet from entering or exiting the house or room when the owner so desires.

However, these permanent pet doors have certain disadvantages, including, without limitation, the fact that the owner must remember that even when the door is closed or locked the pet door may remain open. If the owner overlooks this fact and leaves the premises with the pet door open there is a possibility that wild animals (such as opossums, raccoons, rats, mice and other feral creatures) or neighbors pets may enter the house while the owners are away. If the house is left with the pet door open during a lengthy period of time, such as a vacation, the house may be invaded and become inhabited by such undesirable animals.

Furthermore, depending upon the size of the opening, it may be possible for an intruder to enter the house by way of the pet door. Even if the opening is too small for an adult human body to pass through, an intruder may be able to access the door lock from the inside by sticking his or her arm through the pet door, by using an instrument and/or by using a child or other diminutive accomplice.

Additionally, while conventional pet doors may be useful, they require a substantial and more or less permanent alteration of an existing door. For renters, such an alteration may violate a lease or rental agreement or may be expensive or impractical.

### SUMMARY OF THE INVENTION

The present invention is directed to methods and compositions involving a new type of pet-accessible aperture comprising a curtain that does not require a permanent alteration to, or replacement of an existing structure, such as an existing door or wall in a room or house. The pet curtain is easily removable, and is structured to substantially maintain heat or cold within, and moisture, dust and flying insects outside a room or structure, while at the same time permitting the pet to enter or exit the room or structure at will. The invention requires no tools or special equipment or skill to install or remove.

The pet curtain is preferably structured to be installed in a slightly or entirely opened sliding window or door frame, such as a sliding glass door or a full length-sliding window. Thus, in one embodiment the invention is directed to a pet curtain comprising a curtain having a top edge, a first and second lateral edge, and a bottom edge. The curtain includes at least one vertical slit which begins at and runs substantially perpendicular to the bottom edge. The slit or slits may run partly or substantially entirely along the length (top to bottom axis) of the curtain, forming two or more vertical flaps. In one preferred embodiment the slit or slits do not run entirely along the length of the curtain. The curtain is at least partly comprised of a fabric or material having sufficient weight that it permits the flaps of the curtain to remain closed when the door is not being used, thus keeping insects, heat cold and/or moisture from easily passing into the room or structure. The material of the flaps in particular may be chosen from a medium or heavier cotton weave or synthetic fabric, or, preferably from a polymeric material such as, without limitation, vinyl or polyvinyl chloride (PVC).

Preferably, although not exclusively, the curtain is at least partly comprised of a flexible polymeric material having thermal insulating properties, such as vinyl and polyvinyl chloride. The polymeric material may have thickness dimensions from about 1 mm to about 6 mm, with the optimal thickness generally, although not invariably, from about 2 mm to about 4 mm. The curtain flaps are generally of uniform size, and may be from about 2 inches wide to about 20 inches wide or from about 5 mm wide to about 50 mm wide. It will be understood that each range of dimensions provided in this application is intended to encompass each and every specific point and other range existing within it, unless specifically otherwise indicated. The polymeric material is preferably, though not necessarily invariably, clear. In one embodiment the curtain is clear, in another embodiment the curtain is colored; in another embodiment the curtain is opaque.

The top portion of the curtain comprises an attachment point for the presently claimed pet curtain; for example, the portion of the curtain comprising a) the top edge and b) the area of the curtain running parallel to the top edge and extending about 1, or about 2, or about 3, or about 4, or about 5, or about 6, or about 8, or about 10, or about 12 or more inches downward from the top edge of the curtain, is preferably of a substantially single piece construction. This top portion preferably is adapted to contain one or more clamp, hook, or other fastening structure whereby the user may affix the curtain to a top of a sliding window or door, such as a sill of the window or door. Preferably, such fastening structure is made such that attachment points are located substantially evenly along the top portion of the curtain, thus ensuring a snug installation by which insects, dust, heat and cold are largely prevented from passing past the curtain. The number of attachment points may be as few as one or two; however depending in part on the width and weight of the curtain additional intermediate attachment points may be present. Generally the curtain is at least the width of the largest animal intended to pass through it.

The curtain's length is generally substantially the same length as that of the sliding window or door from whose frame it is installed. Typically, therefore the overall length of the curtain (top edge to bottom edge, is from about 96 inches to about 84 inches, but may be longer than this in certain cases, for example, that of a “cathedral”-type ceiling, and may be shorter, for example, when a window or door does not extend the entire distance from floor to ceiling.

In a particularly preferred embodiment the pet curtain comprises a curtain having a top edge, a bottom edge and a first and second lateral edge. In this embodiment, the curtain comprises two or more overlapping flaps. For example, rather than being comprised of a single piece of material a portion of the curtain comprises two or more strips of material that are stitched, heat sealed, or otherwise affixed to a top portion of the curtain, in an overlapping configuration to form flaps. By overlapping the curtains flaps, the curtain more effectively prevents moisture, dust, and flying insects from passing from the interior to the exterior of a room, or vice versa. The region of overlap between adjacent flaps may comprise about 0.5 inches, or about 1 inch, or about 2 inches or about 3 inches or more.

In this embodiment of the curtain, the flaps are stitched, heat-sealed or otherwise affixed together so as to cause the flaps to overlap with each other. The flaps therefore may be made from individual strips of the same or a different material (such as a polymeric material, including vinyl and PVC) as the remainder of the curtain. The top portion of the curtain may be made from a single piece of the same or a different material from that of the flaps. Preferably the top portion and flaps of the curtain are made of the same material.

The individual flaps may be anywhere from about 1 or 2 inches in width to six or 8 inches or more. This width may depend in part on the weight of the material; the overall weight of a flap should be small enough to permit a pet to easily displace the flap as it walk through the pet curtain. Preferably the flaps are about 4 to 8 inches wide.

In another embodiment the present invention is directed to a door or window frame comprising a door or window frame assembly permitting the ingress and egress of pets from a room comprising

a) a top frame component and a bottom frame component and defining a first aperture area,

b) a fully or partially open door or window corresponding to a second aperture area which comprises a first portion of the first aperture area, and

c) a pet curtain occupying a third aperture area which comprises a third aperture area and consists of a second portion of the first aperture area, and wherein the sum of the second and third aperture areas equals the first aperture area;

wherein the pet curtain comprises a curtain having a top edge, a bottom edge and first and second lateral edges, at least two flaps comprising strips of material extending downward when in use from a top portion of the curtain substantially to a base of the window or door frame, and a fastening structure for attaching the curtain to the top of the door frame. It will be understood that by the partially open door or window “corresponding to” the second aperture area is meant that the second aperture area is the area of the door or window that remains within the first aperture area. If the door or window is completely open, this second aperture area is zero. If a sliding door is half open, the second aperture area is that portion of the first aperture is occupied by the partially open door; in this example, that area would be one half the first aperture area.

Preferably, the curtain comprises a polymeric material such as PVC or vinyl. Also, preferably the strips are stitched, heat-sealed or otherwise attached to the top portion of the curtain so as to overlap with each other along their length.

In this embodiment the first aperture area may consist of the entire area occupied by the door or window when the door or window is closed. In the event that the sliding door or window comprises a movable window or door portion and an immovable window or door portion, the first aperture area may be the area of the door or window frame that corresponds to the movable door or window portion thereof.

Preferably the curtain comprises a clear polymeric material such as vinyl or PVC.

It will also be understood that while the invention has heretofore been described with regard to a sliding door or window, the curtain described herein may be manufactured to permit the attachment of the pet curtain to the frame of any window or door, provided that once attached the curtain substantially prevents undesired dust, moisture, or flying insects from passing beyond the door or window frame. For example, the curtain may substantially cover the entire door or window frame.

In another embodiment the invention comprises a method of permitting the entry or egress of a pet through a door or window comprising at least partly opening said door or window, and attaching a pet curtain comprising a curtain having a top edge, a bottom edge and first and second lateral edges, at least one slit at least partially extending vertically from the bottom edge towards the top edge, and a fastening structure for attaching the curtain to the top of the sliding door frame. The curtain preferably is constructed using a polymeric material such as vinyl or PVC. The pet curtain may have thickness dimensions from about 1 mm to about 6 mm, with the optimal thickness generally, although not invariably, from about 2 mm to about 4 mm. The curtain flaps are generally of uniform size, and may be from about 2 inches wide to about 20 inches wide or from about 5 mm wide to about 50 mm wide.

In another embodiment the invention comprises a method of permitting the ingress and egress of pets between a room and a desired location adjacent the room while providing insulation of said room against the substantial intrusion of heat, cold, and/or dust, comprising

a) wholly or partially opening a door or window leading from the room to the desired location,

b) attaching to a top door or window frame component a pet curtain comprising a curtain having a top edge, a bottom edge and first and second lateral edges, at least two flaps comprising strips of material extending downward when in use from a top portion of the curtain substantially to a base of the window or door frame, and a fastening structure for attaching the curtain to the top of the door or window frame, and

c) providing a pet access to said pet curtain.

In this embodiment the pet curtain may comprise two or more overlapping flaps. For example, rather than being comprised of a single piece of material a portion of the curtain may comprise two or more flaps that are stitched, heat sealed, or otherwise affixed to a top portion of the curtain, in an overlapping configuration. The flaps may comprise strips of material of substantially equal length and width.

It will be understood that the descriptions of particular embodiments provided herein are not intended to limit, and do not limit the scope of the invention as defined by the claims which conclude this specification, which will be apparent to the person of ordinary skill in the art. Any feature described herein may be combined with any other feature, or removed from any described combination of features, and the resulting composition shall be deemed as having been particularly described in this specification.

### BRIEF DESCRIPTION OF THE DRAWING

FIG. 1 is an illustration of one embodiment of the pet curtain of the present invention comprising a curtain of material having a top portion having attachment holes or slots through which clips are attached, a horizontal seam, and a lower portion comprising overlapping flaps.

FIG. 2 is an illustration of one embodiment of the window or door frame assembly of the present invention comprising a sliding door assembly in which the sliding door is partially opened and the pet curtain is attached in the resulting gap to the top frame component.

### DETAILED DESCRIPTION OF THE INVENTION

The present invention concerns a pet curtain comprising a curtain comprising a medium to heavy-duty fabric or polymeric material. Preferably, the curtain is made from a polymeric material such as vinyl or PVC, although any flexible, waterproof or water-resistant stable polymeric material may suffice.

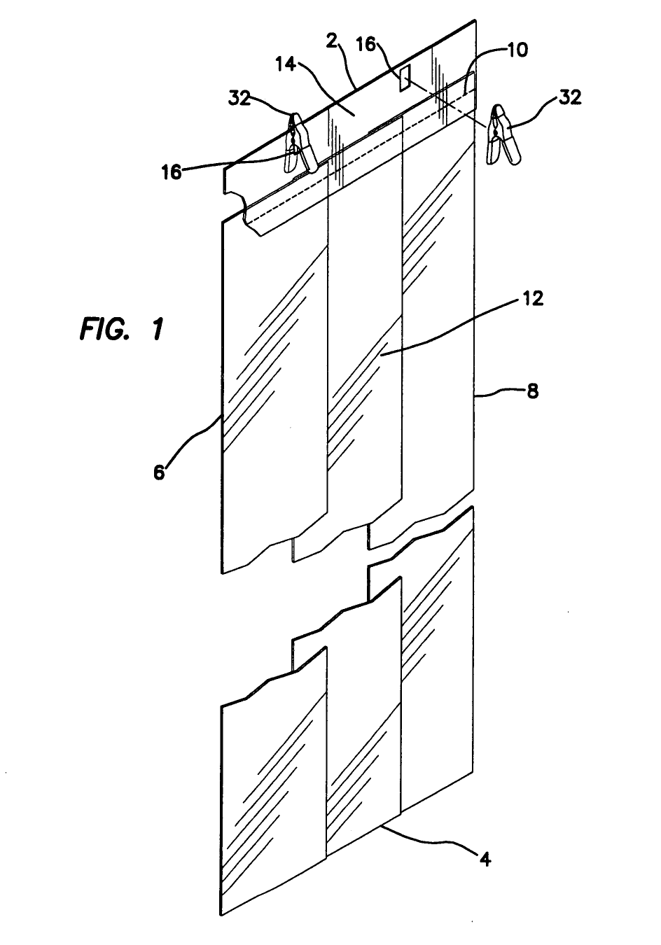

In one embodiment shown in FIG. 1, the pet curtain of the present invention comprises a curtain comprised of polyvinyl chloride having a top edge (2) a bottom edge (4) and first (6) and second (8) lateral edges. The curtain contains a series of substantially evenly spaced vertically hanging flaps with each such flap comprising a strip of curtain material of substantially equal length and substantially equal width (12) as each other strip, except one or more end strips, which may vary somewhat. In this embodiment the plurality of flaps are stitched together along a horizontal seam (10) and to a top portion of the curtain (14) comprising a single sheet of curtain material such that each flap overlaps and/or underlaps with each adjacent flap.

The length of the flaps should be at least approximately the height of the largest pet using the pet curtain to enter or exit the room or structure. However, the flaps need not be sized on a custom basis; so long as the doorway or window frame is at least as high as the pet, the flaps may be affixed to the top portion of the curtain at a location any distance from the top edge of the curtain permitting passage of the pet between the flaps. For example, the horizontal seam may be located within 24 inches or more, or within 18 inches, or within 16 inches or within 14 inches, or within 12 inches, or within 10 inches or within 8 inches or within 6 inches or within 4 inches or within 2 inches or less from the top edge of the curtain. Preferably, although not necessarily critically, the horizontal seam (10) terminates at a point between 18 inches and 6 inches from the top edge of the curtain.

The portion of the curtain proximal to the top edge is structured to permit attachment of the pet curtain to the top of the door or window frame. In one embodiment, as shown in FIG. 1, at least two holes (16) are made in the curtain to permit clamps, clips, straps, snaps or other attachment means to connect the curtain to the door or window frame. In the embodiment shown on FIG. 1, the holes are holes or slots through which clips (32) are used to clamp the pet curtain to the door or window frame. Generally, though not necessarily invariably, the attachment points are horizontally oriented proximal to the top edge and vertically oriented proximal to each lateral edge of the curtain. Depending upon the width of the curtain, intermediate attachment points may be desirable to prevent the curtain from drooping when in use. In one embodiment, intermediate holes may be placed between the holes that are proximal to each lateral edge of the curtain.

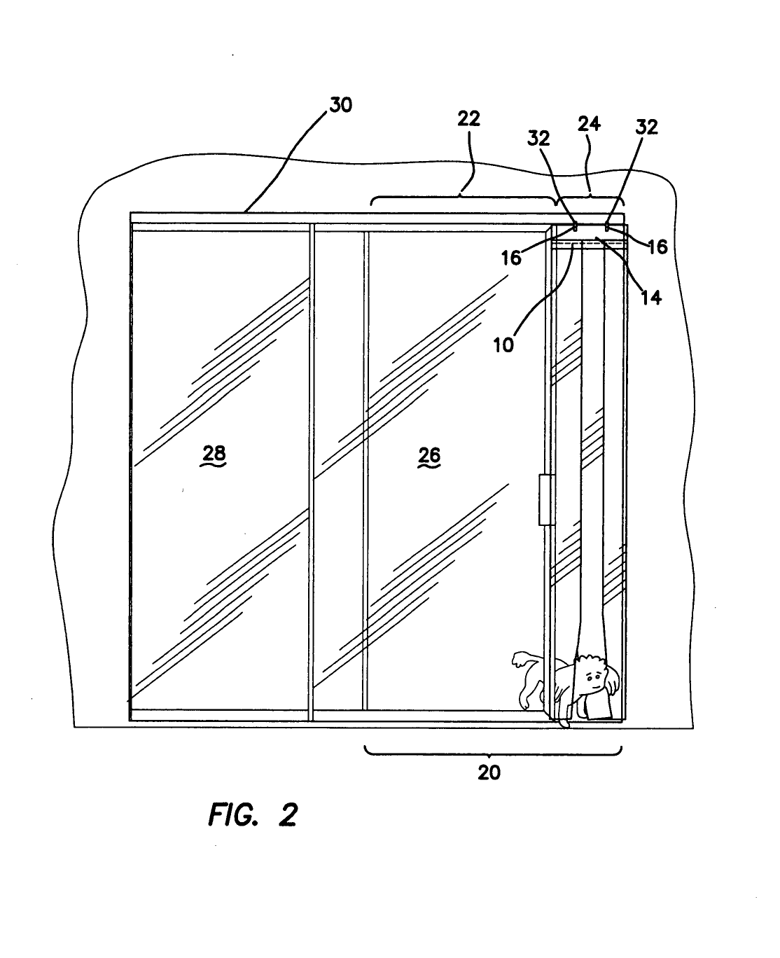

FIG. 2 shows an embodiment of the pet curtain of the present invention in use. In this figure, a sliding glass door frame assembly is shown (30) comprising a movable sliding door portion (26) and an immovable glass door portion (28). In FIG. 2 the sliding glass door portion is shown partly open. A first aperture (20) is shown comprising the area of the door frame that is occupied by the sliding glass door when it is completely closed. A second aperture area (22) is shown comprising that portion of the first aperture area that is occupied by the partially open sliding glass door. A third aperture area (24) comprising the first aperture area minus the second aperture area is shown occupied by the pet curtain of the present invention. Also detailed in this view of the pet curtain are the holes (16) in the top portion (14) through which clips (32) are inserted and used to clamp the pet curtain to the top of the window frame, the horizontal seam (10) and overlapping flaps (12) of the curtain.

As can be seen, when the pet curtain is in place, the flaps extend downwards and are relatively immovable in, for example, a gentle breeze due to the weight of the material from which they are made. Additionally, and particularly when the flaps are made to overlap each other, when the pet curtain is installed it prevents heat or cooling loss and ingress of flying insects between rooms or indoors and outdoors.

An important consideration is that the material from which the flaps are made be sufficiently heavy to remain closed and relatively air and watertight, and yet sufficiently light to permit the pet to displace and pass between the flaps without substantial effort. Generally, although not necessarily, the pet curtain can be made using vinyl or PVC sheets for the top portion and/or the flaps. Flaps of this sort are sometimes used in the food industry.

Preferably, the pet curtain is substantially clear or translucent. This feature permits light to enter the room from outdoors and thus prevents the pet curtain from substantially darkening the room in which it is installed. Alternatively, in less preferred (but still encompassed) embodiments the pet curtain may be colored or tinted, or indeed opaque if so desired.

Advantageously, the pet curtain can be easily removed and stored. Alternatively, the curtain may be left in place if installed on the outside of the door or screen or may be rolled up when noty in use. When leaving a dwelling or structure it is usual for the owner to ensure that the doors and windows are locked. The pet curtain, when installed, is obviously present and will be seen when the owner locks the doors of the dwelling or structure. Therefore the pet curtain of the present invention itself acts as a reminder that the pet curtain must be either removed or left in place fastened, for example, to the outside of the door or window frame, and the window or door closed, before the owner leaves the premises. For this reason, the pet curtain of the present invention is less likely to render the house insecure than would many existing pet doors which may remain open even when the door or window on which they are installed is locked. Therefore, an advantage of the present invention is the added security provided thereby.

Also, the presently described pet curtain is ideal for pet owners who live in rented or leased dwellings, are traveling and in hotels, motels, or vacation cabins, or for pet sitters. Since the present pet curtain does not require modification or replacement of existing walls, doors or windows and is easily removed, pet owners may use a pet curtain without fear of violating rental or lease agreements preventing such modifications from being made.

The present pet curtain is also easily and inexpensively constructed, and requires no wood or metal and no moving parts. As such the pet curtain is considerably more affordable that existing pet doors.

The claims that follow this specification define the invention, which shall not be considered limited to the embodiments explicitly exemplified herein. Although the foregoing invention has been described in detail for purposes of clarity of understanding, it will be obvious that certain modifications may be practiced within the scope of the appended claims.

I claim:

1. A pet curtain comprising a curtain having a top edge, a bottom edge, a first lateral edge and a second lateral edge, wherein the curtain comprises
a) a top portion comprising two attachment means located vertically proximal to the first and second lateral edge, respectively, and horizontally proximal to the top edge, and
b) a bottom portion comprising two or more flaps extending, when in use, from the top portion substantially to a floor, window sill or door sill.

2. The pet curtain of claim 1 wherein the top and bottom portions of the curtain are made of a material selected from the group consisting of vinyl and PVC.

3. The pet curtain of claim 1 wherein each of the two or more flaps is attached to the top portion of the curtain in a manner such that it overlaps or is overlapped by at least one other flap.

4. The pet curtain of claim 1 wherein each said attachment means comprises a hole or slot in the top portion of the curtain.

5. The pet curtain of claim 1 comprising at least one additional attachment mean located vertically between and horizontally proximal to the top edge and substantially collinear with the other attachment means.

6. A door or window frame assembly permitting the ingress and egress of pets from a room comprising
a) a top frame component and a bottom frame component and defining a first aperture area,
b) a fully or partially open door or window, corresponding to a second aperture area which comprises a first portion of the first aperture area, and
c) a pet curtain occupying a third aperture area, which aperture area consists of a second portion of the first aperture area, and wherein the sum of the second and third aperture areas equals the first aperture area;
wherein the pet curtain comprises a curtain having a top edge, a-bottom edge and first and second lateral edges, at least two flaps comprising strips of material extending downward when in use from a top portion of the curtain substantially to a base of the window or door frame, and a fastening structure for attaching the curtain to the top of the door or window frame, and wherein if the door or window is fully open, the second aperture area is 0.

7. The assembly of claim 6 wherein each of the at least two curtain flaps is attached to the top portion of the curtain in a manner such that it overlaps or is overlapped by at least one other flap.

8. The assembly of claim 6 wherein said fastening structure comprises two or more clips, straps, hooks or holes, or a mixture thereof.

9. The assembly of claim 6 wherein the door or window frame is a sliding door or window frame.

10. The assembly of claim 6 wherein the door or window frame is not a sliding door or window frame.

11. The assembly of claim 6 in which the curtain comprise a vinyl or PVC polymer.

12. A method of permitting the ingress and egress of pets between a room and a desired location adjacent the room while providing insulation of said room against the substantial intrusion of heat, cold, and/or dust, comprising
a) wholly or partially opening s door or window leading from the room to the desired location,
b) attaching to a top door or window frame component a pet curtain comprising a curtain having a top edge, a bottom edge and first and second lateral edges, at least two flaps comprising strips of material extending downward when in use from a top portion of the curtain substantially to a base of the window or door frame, and a fastening structure for attaching the curtain to the top of the door or window frame, and
c) providing a pet access to said pet curtain.

13. The method of claim 12 wherein each of the at least two curtain flaps is attached to the top portion of the curtain in a manner such that it overlaps or is overlapped by at least one other flap.

14. The method of claim 12 wherein the curtain comprise a vinyl or PVC polymer.

15. The method of claim 12 wherein the door or window is a sliding door or window.

16. The method of claim 12 wherein said curtain substantially covers the aperture resulting from opening the door or window.

17. The method of claim 12 wherein the room is located within a structure and the desired location is located outside said structure.

18. The method of claim 12 wherein each of the at least two curtain flaps is attached to the top portion of the curtain by stitching or heat-sealing.

19. The method of claim 13 wherein each of the at least two curtain flaps is attached to the top portion of the curtain by attachment means selected from the group consisting of stitching or heat-sealing.

20. The method of claim 16 wherein the door or window is not a sliding door or window.
